(19) United States
(12) Patent Application Publication
(10) Pub. No.: US 2007/0068392 A1
(43) Pub. Date: Mar. 29, 2007

(54) Durable coffee pot system

(76) Inventor: Sung Suk Kim, Portland, OR (US)

Correspondence Address: Sung Suk Kim, SID #8075233, 82911 Beach Access Rd., Umatilla, OR, 97882, US

(21) Appl. No.: 11/237,416

(22) Filed: Sep. 27, 2005

(51) Int. Cl. A23L 1/00

(52) U.S. Cl. 99/275

(57) ABSTRACT

A durable coffee pot system for use in preparing coffee or other beverages and food items. The system consists of a pot with lid, handle, and spout all constructed of ⅛th inch thick carbon fiber material. Hook eyes are fabricated into the pot body to allow it to be suspended over an open source of heat. The cylindrical pot is highly durable, being fire resistant and not subject to damage including breakage or warpage. It's extremely high durability allows the pot to be used with nearly any heat source including stove-top, open flame, or microwave oven. The system also employs a threaded screw-top filter cylinder which is constructed of carbon fiber. The filter contains numerous small holes. The filter floats freely in the pot and is agitated by the action of boiling water. This allows the coffee to be extracted more completely and up to two-times more quickly than conventional percolator systems. The coffee pot system retains it's integrity to temperatures of 5,400 degrees Fahrenheit (3,000 degrees Celcius).

### CROSS-REFERENCE TO RELATED APPLICATIONS

Not Applicable

### FEDERALLY SPONSORED RESEARCH

Not Applicable

### REFERENCE TO COMPACT DISC APPENDIX

Not Applicable

### BACKGROUND OF THE INVENTION

The present invention relates to a highly durable container manufactured of carbon fiber for use in preparing coffee or other beverages or food items. The container is unaffected by extremely high temperature and is suitable for use on a stove-top or over open flame. It cannot be broken or warped except in the most severe of circumstances. The invention also employs a free-floating filter system designed to offer maximum use of ground coffee beans.

### BRIEF SUMMARY OF THE INVENTION

It is the primary object of the invention to provide a container for use in heating liquids and cooking which is constructed of extremely durable carbon fiber material which will not crack or shatter when dropped. The material is highly heat resistant to 5,400 degrees Fahrenheit (3,000 degrees Celcius), thus preventing melting or warpage of the pot regardless of the amount of heat applied or in the event that the liquid within the container fully evaporates. This affords a significant improvement over traditional pots which are made of glass or metals. The carbon fiber construction is sufficiently durable that the product will remain intact for the lifetime of the user.

It is another object of the present invention to employ a filtering device consisting of a carbon fiber cylinder with multiple holes. The sealed cylinder containing ground coffee is placed directly into the pot. The coffee extracts via agitation provided by boiling water in the pot, providing a minimum of 98 percent recovery of usable coffee from the cylinder. The coffee continues to extract from the filter even when removed from heat, as it remains in contact with the liquid. The process allows coffee to be utilized more completely, and up to twice as fast preparation time is achieved over conventional percolator systems. There is no support structure for the filtering cylinder, which floats freely in the liquid of the pot. This results in a savings of material in manufacture and an increase in simplicity of use.

### BRIEF DESCRIPTION OF THE SEVERAL VIEWS OF THE DRAWINGS

The embodiment of the invention is illustrated in it's design and construction and will be more fully understood from the following description, when read in conjunction with the accompanying drawings where:

FIG. 1 is an overall view of the durable coffee pot system. This variation showing the 16 cup coffee pot (using 6 ounce cups). The cylindrical, seven inch diameter, fourteen inch height pot is shown along with lid, filtering cylinder, and a demonstration of a hanger connected to hook eyes designed to allow the pot to be suspended over an open flame source such as a campfire.

FIG. 2 shows a detailed view of the pot system more clearly depicting the lid design and how it fits onto the pot. The cap of the filtering cylinder device is shown in more detail.

### DETAILED DESCRIPTION OF THE INVENTION

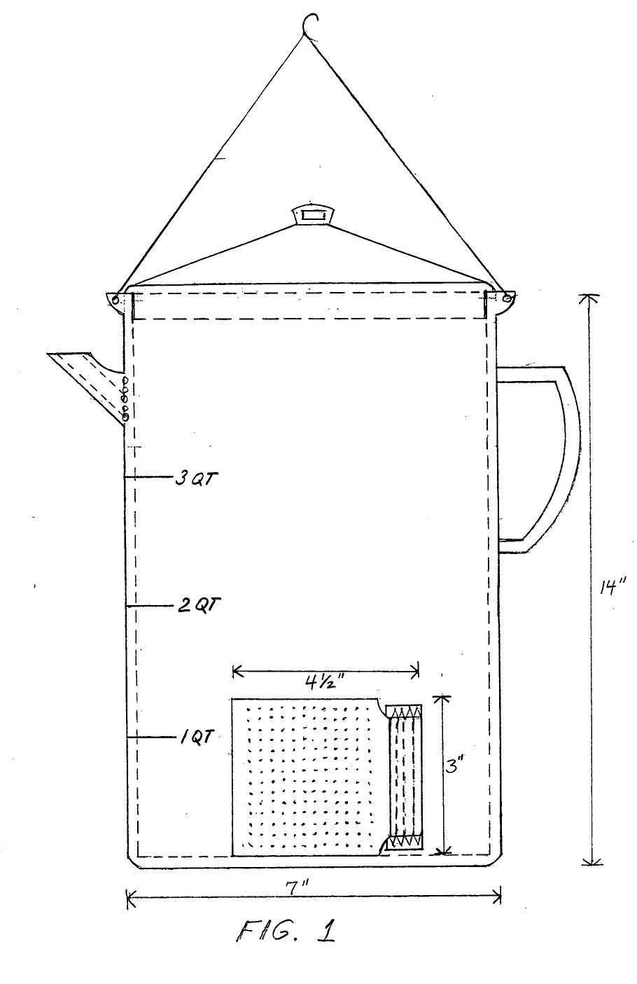

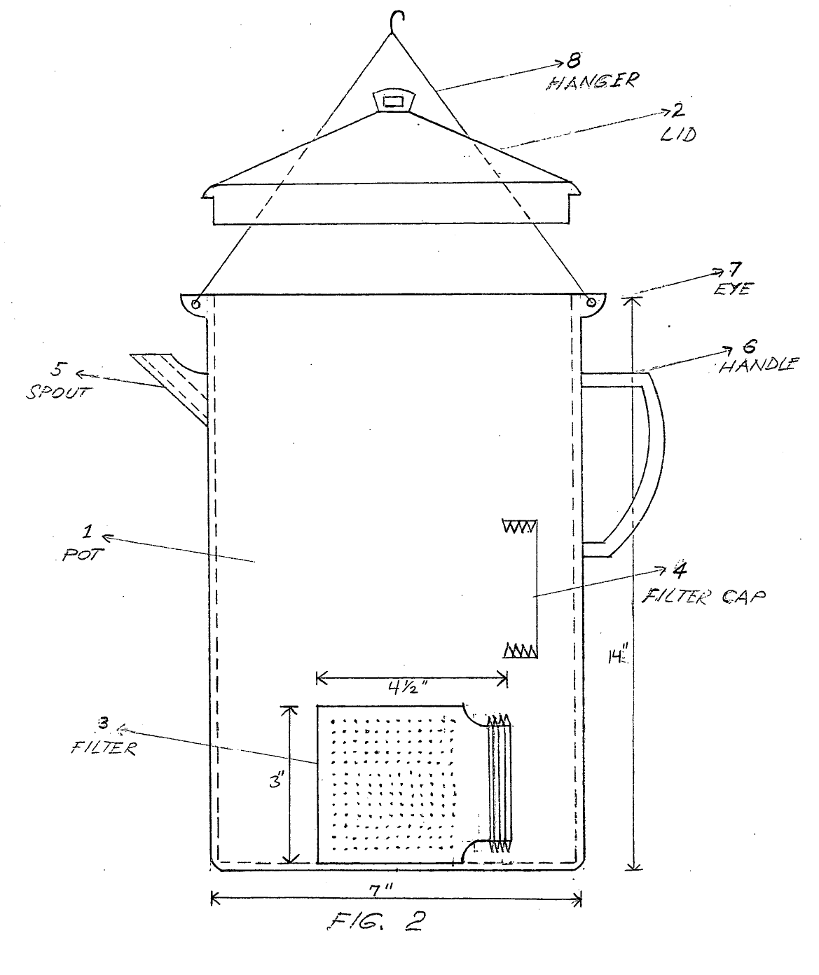

The Durable Coffee Pot System is depicted in FIGS. 1 and 2 which show a side-view of the container and lid, as well as the filtering cylinder.

Referring to FIG. 1 the container lid 2 is secured onto the main pot body. The filter 3 is shown with filter cap 4 attached. The container shown is seven inches in diameter as measured from the bottom. and fourteen inches in height. The total capacity is one-gallon, to the top of the pot. The three quart level represents a full 16-cup fill-line. The thickness of the Carbon Fiber material is represented by the inner dashed-line and is one-eighth inch on all surfaces. Filter 3 is 3 inches diameter by 4.5 inch length.

FIG. 2 is a view of the pot 1, with a detail of it's individual parts. The lid 2 of the pot is shown detached from the pot body, demonstrating that the lid 2 fits snugly inside of the container walls, while the lid top slightly overlaps the container edge to prevent any liquid, condensation, or contaminants from entering the pot. A grippable handle is at the peak of the angled lid. A coffee filter device 3 is a cylindrical container with multiple small holes of sufficient diameter to allow water to pass through the opening, while preventing coffee grounds from exiting the small holes. The coffee grounds are secured within the filter device 3 by means of a threaded filter cap 4. Liquid is poured from the pot by means of the carbon fiber spout 5. The pot can be picked-up and manipulated by means of the handle 6 which can be gripped firmly by a hand. Two round eyes 7 are placed in horizontal extensions at opposing exterior points at the top of the pot. The eye 7 allows a hanger 8 to be hooked onto the pot for the purpose of hanging over a source of open flame such as a campfire, Hanger 8 is not an integral part of the invention and patent protection is not sought for this portion of the figure.

While certain novel features of the Durable Coffee Pot System have been shown and described either in-part or in-full and pointed out in the annexed claims, it is not limited to those details, since it is understood that various omissions, modifications, substitutions and/or changes in the forms and details of the invention illustrated and in it's operation can be made by those skilled in the art without departing from, in any way, the spirit of the present invention.

Without further analysis, the foregoing will so fully reveal the art of the Durable Coffee Pot System that others can by applying current knowledge, readily adapt it for various applications without omitting features that from the standpoint of prior art, fairly constitute essential characteristics and the generic or specific aspects of this invention.

What I claim as my invention is as follows:

1. A coffee pot with lid and accompanying features which is crafted wholly of highly heat-resistant carbon fiber material.

2. A coffee filter cylinder constructed of carbon fiber which floats freely within the pot, where the ground coffee is extracted by means of the agitation of the boiling water in the pot.
